(19) United States
(12) Patent Application Publication
(10) Pub. No.: US 2019/0392005 A1
(43) Pub. Date: Dec. 26, 2019

(54) SPEECH DIALOGUE SYSTEM, MODEL CREATING DEVICE, MODEL CREATING METHOD

(71) Applicant: Hitachi, Ltd., Tokyo (JP)

(72) Inventors: Masaaki YAMAMOTO, Tokyo (JP); Kenji NAGAMATSU, Tokyo (JP); Makoto IWAYAMA, Tokyo (JP)

(21) Appl. No.: 16/420,479

(22) Filed: May 23, 2019

(30) Foreign Application Priority Data
Jun. 22, 2018 (JP) 2018-119325

(51) Int. Cl. G06F 16/9032; G10L 15/06; G10L 15/26; G06N 20/00

(52) U.S. Cl. CPC G06F 16/90332; G10L 15/063; G10L 2015/0631; G06N 20/00; G10L 15/265

(57) ABSTRACT

A speech dialogue system automatically creates a plurality of slot value extraction models. The speech dialogue system includes: a value list in which a plurality of values indicating candidates of a character string and a plurality of value identifiers that identify the plurality of values are associated; and an answer sentence list in which slots that identify character string information and the value identifiers are associated. Each slot and each value identifier are associated with an answer sentence. An input character string is compared with slot value extraction models. A position of a slot associated with an assumed input character string is estimated, and a value corresponding to the estimated slot position is extracted. Learning data based on the value list, answer sentence list, and a peripheral character string list is created; and a model creating unit creates a first slot value extraction model based on the learning data.

### CROSS-REFERENCE TO RELATED APPLICATION

The present application claims priority from Japanese application JP 2018-119325, filed on Jun. 22, 2018, the contents of which is hereby incorporated by reference into this application.

### BACKGROUND OF THE INVENTION

The present invention relates to a speech dialogue system, a model creating device, and a model creating method.

As a related text dialogue system (hereinafter, related system), there is a system which outputs a plurality of question sentences to a user and displays information based on a plurality of answer sentences input by the user. For example, when the related system is used to provide a service of displaying a riding time, the related system prompts a user to input a place of departure and a destination and displays a riding time based on information on the input departure place and destination.

For example, an example of techniques relating to the related system includes a technique described in JP-A-2015-225402. JP-A-2015-225402 describes an information retrieval device that includes: a storage unit which stores a plurality of response contents including an assumed answer and an asking-back question to lead to the assumed response; a reception unit which receives a user question; a retrieval unit which retrieves the plurality of response contents on the basis of the user question received by the reception unit and acquires either the assumed answer or the asking-back question corresponding to the user question; and an output unit which outputs a response content acquired by the retrieval part.

In the technique described in JP-A-2015-225402, it is necessary to previously determine the order of user questions. Therefore, as a speech dialogue system that appropriately selects and outputs answer sentences and question sentences in response to the user questions, attempts have been made to construct a speech dialogue system that includes a slot value extraction unit and a plurality of slot value extraction models. However, it is necessary to manually create a large number of assumed input character strings used to create the slot value extraction models, which results in a problem of complicated operation.

### SUMMARY OF THE INVENTION

An object of the invention is to automatically create a plurality of slot value extraction models.

In order to solve the problems, the invention provides a speech dialogue system that converts an input speech to be input into information of an input character string, creates an output character string containing information of an answer sentence or a question sentence based on the converted information of the input character string, converts information of the created output character string into a synthetic speech, and outputs the converted synthetic speech as an output speech. The speech dialogue system includes: a value list in which a plurality of values indicating candidates of a character string assumed in advance, which are information constituting a character string, and a plurality of value identifiers that identify each of the plurality of values are stored in association; an answer sentence list in which each of a plurality of slots indicating an identifier that identifies the information constituting the character string and each of the plurality of value identifiers are stored in association, and each of the plurality of slots and each of the plurality of value identifiers are stored in association with one or more answer sentences; a peripheral character string list in which each of the plurality of slots and each of a plurality of peripheral character strings arranged adjacent to each of the plurality of slots are stored in association; a storage unit that stores a plurality of assumed input character strings assumed in advance and a plurality of slot value extraction models including one or more of the slots and the values associated with each of the plurality of assumed input character strings; a slot value extraction unit that compares a similarity between the input character string and each of the assumed input character strings in the plurality of slot value extraction models, estimates a position of a slot in the input character string based on a slot associated with an assumed input character string having a high degree of similarity, and extracts a value corresponding to the estimated position of the slot from the input character string; a learning data creating unit that creates first learning data based on the value list, the answer sentence list, and the peripheral character string list; and a model creating unit that creates a first slot value extraction model based on the first learning data and stores the created first slot value extraction model in the storage unit as a model belonging to the plurality of slot value extraction models.

### Effect of the Invention

According to the invention, a plurality of slot value extraction models can be automatically created. As a result, work cost required for creating the slot value extraction models can be reduced.

### BRIEF DESCRIPTION OF THE DRAWINGS

FIG. 1 is a block diagram showing an overall configuration of a speech dialogue system and a text dialogue system according to a first embodiment.

FIG. 2 is a configuration diagram showing an example of hardware included in a text dialogue support device and a model creating device according to the first embodiment.

FIG. 3 is a configuration diagram showing an example of a slot value extraction model according to the first embodiment.

FIG. 4 is a configuration diagram showing an example of a value list according to the first embodiment.

FIG. 5 is a configuration diagram showing an example of an answer sentence list according to the first embodiment.

FIG. 6 is a configuration diagram showing an example of a question sentence list according to the first embodiment.

FIG. 7 is a configuration diagram showing an example of a peripheral character string list according to the first embodiment.

FIG. 8 is a configuration diagram showing an example of learning data according to the first embodiment.

FIG. 9 is a process flow diagram showing an example of speech recognition processing of the speech dialogue system according to the first embodiment.

FIG. 10 is a process flow diagram showing an example of speech synthesis processing of the speech dialogue system according to the first embodiment.

FIG. 11 is a process flow diagram showing an example of processing of the text dialogue system according to the first embodiment.

FIG. 12 is a process flow diagram showing an example of processing of the model creating device according to the first embodiment.

FIG. 13 is a process flow diagram showing an example of processing for creating learning data from which only an assumed input character string related to a specific slot is removed according to a second embodiment.

FIGS. 14A and 14B are configuration diagrams showing examples of the learning data from which only an assumed input character string related to the specific slot is removed according to the second embodiment.

FIG. 15 is a configuration diagram showing an example of a dialogue log according to a third embodiment.

FIG. 16 is a configuration diagram showing an example of a management table according to the third embodiment.

FIGS. 17A to 17D are configuration diagrams showing examples of learning data according to the third embodiment.

### DESCRIPTION OF EMBODIMENTS

### First Embodiment

An embodiment of the invention will be described in detail below with reference to drawings.

(Configuration of Speech Dialogue System 2000)

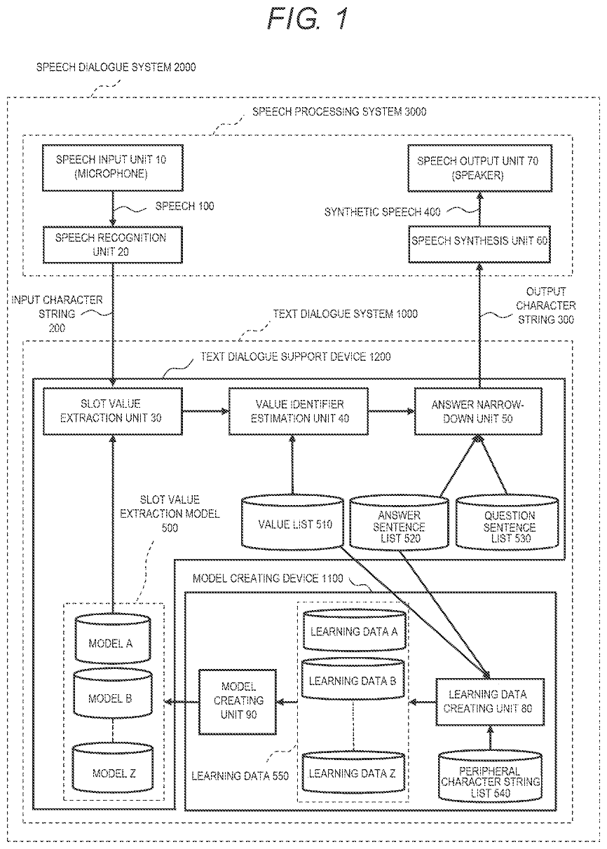

FIG. 1 is a block diagram showing an example of a configuration of a speech dialogue system according to a first embodiment of the invention. The speech dialogue system 2000 according to the first embodiment is, for example, a so-called dialogue robot (service robot) that performs speech dialogue with a human. The speech dialogue system 2000 includes a speech processing system 3000 that performs input and output processing of a speech related to a dialogue and a text dialogue system 1000 that performs information processing related to the dialogue.

The speech processing system 3000 includes a speech input unit 10 that includes a microphone or the like and from which a speech is input, a speech recognition unit 20 that removes a sound (noise) other than a speech from a speech 100 input from the speech input unit 10 and converts the speech from which the noise has been removed into character string information (input character string 200), a speech synthesis unit 60 that creates a synthetic speech 400 according to an output character string 300 output from the text dialogue system 1000, and a speech output unit 70 that includes a speaker and the like and outputs a predetermined synthetic speech from the synthetic speech 400 created by the speech synthesis unit 60.

The text dialogue system 1000 includes a text dialogue support device 1200 and a model creating device 1100. The text dialogue support device 1200 is connected to the speech processing system 3000 and transmits the corresponding output character string 300 to the speech processing system 3000 by performing predetermined information processing based on the input character string 200 received from the speech processing system 3000.

The text dialogue support device 1200 includes a slot value extraction unit 30, a value identifier estimation unit 40, an answer narrow-down unit 50, a plurality of slot value extraction models 500, a value list 510, an answer sentence list 520, and a question sentence list 530. The slot value extraction unit 30 refers to the plurality of slot value extraction models 500, estimates an identifier (hereinafter referred to as slot) related to information included in the input character string 200, and extracts a character string (hereinafter referred to as value) related to the slot from the input character string 200. The value identifier estimation unit 40 compares the degree of similarity between the value and a plurality of assumed values registered in advance in the value list 510. Within the value list 510, when there is an assumed value having a high degree of similarity to the value, the value identifier estimation unit 40 determines the identifier of the assumed value (hereinafter, referred to as value identifier) as the value identifier of the value.

The answer narrow-down unit 50 determines whether value identifiers of slots necessary for information display have been prepared. For example, when value identifiers of slots necessary for displaying a riding time have been prepared, the answer narrow-down unit 50 outputs an answer sentence (a character string describing the riding time) associated with the value identifiers. On the other hand, when the value identifiers of the slots are not prepared, the answer narrow-down 50 outputs a question sentence (for example, where is the place of departure?) prompting the user to input information related to the missing slot (for example, <departure place>).

The model creating device 1100 is an information processing device used by an administrator or the like of the speech dialogue system 2000 and the text dialogue system 1000, and creates the slot value extraction model 500 to which the slot value extraction unit 30 refers. The model creating device 1100 includes a learning data creating unit 80, a model creating unit 90, a peripheral character string list 540, and a plurality of learning data 550. The learning data creating unit 80 transmits and receives information to and from the text dialogue support device 1200, acquires information recorded in the value list 510 and the answer sentence list 520, and creates a plurality of the learning data 550 necessary for creating the slot value extraction model 500 based on the information recorded in the value list 510, the answer sentence list 520, and the peripheral character string list 540. The model creating unit 90 creates the slot value extraction model 500 from the learning data 550 by performing conversion processing on the learning data 550, for example, performing processing by machine learning, and transmits the created slot value extraction model 500 to the text dialogue support device 1200.

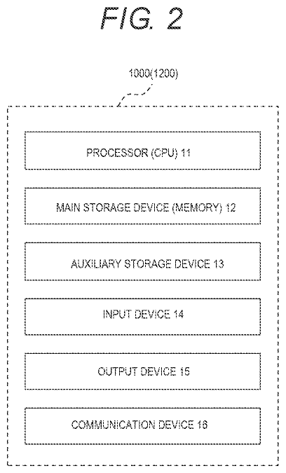

FIG. 2 is a configuration diagram showing an example of hardware included in the text dialogue support device 1200 and the model creating device 1100. As shown in FIG. 2, the text dialogue support device 1200 and the model creating device 1100 include: a processor 11 that controls processing such as a central processing unit (CPU); a main storage device 12 such as a random access memory (RAM) and a read-only memory (ROM); an auxiliary storage device 13 such as a hard disk drive (HDD) and a solid state drive (SSD); an input device 14 such as a keyboard, a mouse, and a touch panel; an output device 15 such as a monitor (display); and a communication device 16 such as a wired LAN card, a wireless LAN card, and a modem. In addition, the text dialogue support device 1200 and the model creating device 1100 are directly connected to each other by a predetermined communication line, alternatively, connected via a communication network such as a local area network (LAN), a wide area network (WAN), the Internet, and a dedicated line.

The plurality of slot value extraction models 500, the value list 510, the answer sentence list 520, the question sentence list 530, the peripheral character string list 540, and the plurality of pieces of learning data 550 are stored in a storage unit configured by the main storage device 12 or the auxiliary storage device 13. In addition, the slot value extraction unit 30, the value identifier estimation unit 40, the answer narrow-down unit 50, the learning data creating unit 80, and the model creating unit 90 can achieve functions thereof through, for example, executing various processing programs (a slot value extraction program, a value identifier estimation program, an answer narrow-down program, a learning data creating program, and a model creating program) stored in the main storage device 12 or the auxiliary storage device 13 by the CPU.

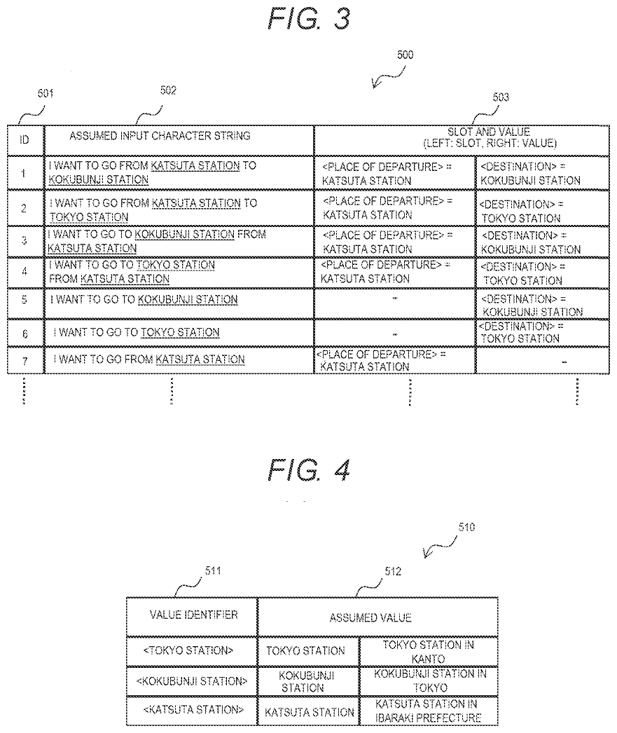

FIG. 3 is a configuration diagram showing a configuration of a slot value extraction model. In FIG. 3, the slot value extraction model 500 includes an ID 501, an assumed input character string 502, a slot and value 503. The ID 501 is an identifier that uniquely identifies the slot value extraction model. The assumed input character string 502 is information defined as an input character string assumed in advance. Information related to an assumed input character string defined in advance is registered in the assumed input character string 502, corresponding to each ID 501. For example, “1” of the ID 501 is registered with information “I want to go from Katsuta Station to Kokubunji Station”. The slot and value 503 is information for managing the slot and the value in the assumed input character string registered in the assumed input character string 502. For example, information of “<place of departure>=Katsuta Station”, “<destination>=Kokubunji Station” is registered in the slot and value 503, corresponding to “1” of the ID 501. Here, “<place of departure>” and “<destination>” are slots, and “Katsuta Station” and “Kokubunji Station” are values. The slot value extraction model 500 may be created by machine learning (for example, a method of conditional random fields) using the assumed input character string defined in advance, the slot, and the value as inputs.

FIG. 4 is a configuration diagram showing a configuration of a value list. In FIG. 4, the value list 510 is a database including a value identifier 511 and an assumed value 512. The value identifier 511 uniquely identifies the value. For example, information of “<Tokyo Station>” is registered in the value identifier 511 as an identifier for identifying “Tokyo Station” which is a value. The assumed value 512 is information indicating a candidate of a character string assumed in advance (previously assumed). Information of the previously assumed value is divided into a plurality of items and registered in the assumed value 512. For example, information of “Tokyo Station” and “Tokyo Station in Kanto” is registered in the assumed value 512, corresponding to “<Tokyo Station>” of the value identifier 511. That is, a plurality of values indicating the candidates of the character strings assumed in advance, which are information constituting the character strings, are attached with a plurality of value identifiers identifying each of the plurality of values and stored in the value list 510. In the assumed value 512, information corresponding to each value identifier 511 is registered with three or more items.

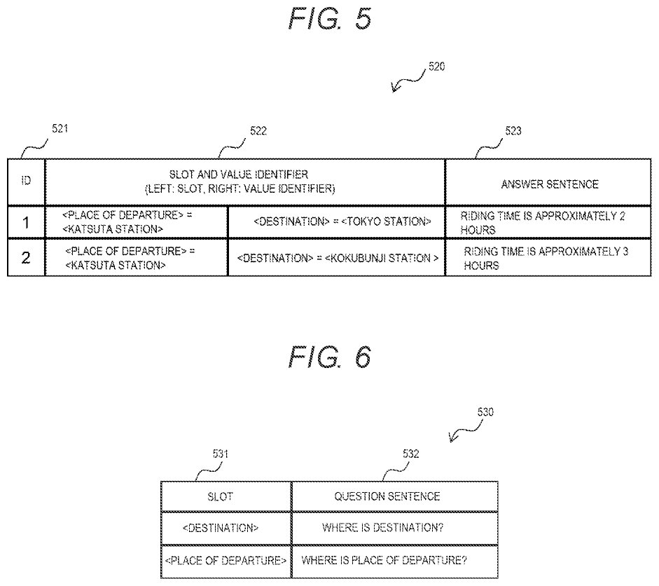

FIG. 5 is a configuration diagram showing a configuration of an answer sentence list. In FIG. 5, the answer sentence list 520 includes an ID 521, a slot and value identifier 522, and an answer sentence 523. The ID 521 is an identifier for uniquely identifying an answer sentence. The slot and value identifier 522 is information for managing the relationship between the slot and the value identifier. For example, information of “<place of departure>=<Katsuta Station>” and “<destination>=<Tokyo station>” is registered in the slot and value identifier 522, corresponding to “1” of the ID 521. Here, “<place of departure>” and “<destination>” are slots, and “<Katsuta Station>” and “<Tokyo station>” are value identifiers. The answer sentence 523 is information on the answer sentence. For example, information of “The riding time is approximately 2 hours.” is registered in the answer sentence 523, corresponding to “1” of the ID 521. That is, each of the plurality of slots indicating identifiers for identifying information constituting character strings and each of the plurality of value identifiers are attached together and stored in the answer sentence list 520, and each of the plurality of slots and each of the plurality of value identifiers are stored in association with one or more answer sentences.

FIG. 6 is a configuration diagram showing a configuration of a question sentence list. In FIG. 6, the question sentence list 530 includes a slot 531 and a question sentence 532. The slot 531 is information for specifying the question sentence 532. For example, information of “<destination>” is registered in the slot 531. The question sentence 532 is information constituting the question sentence. For example, information of “where is the destination?” is registered in the question sentence 532, corresponding to “<destination>” of the slot 531.

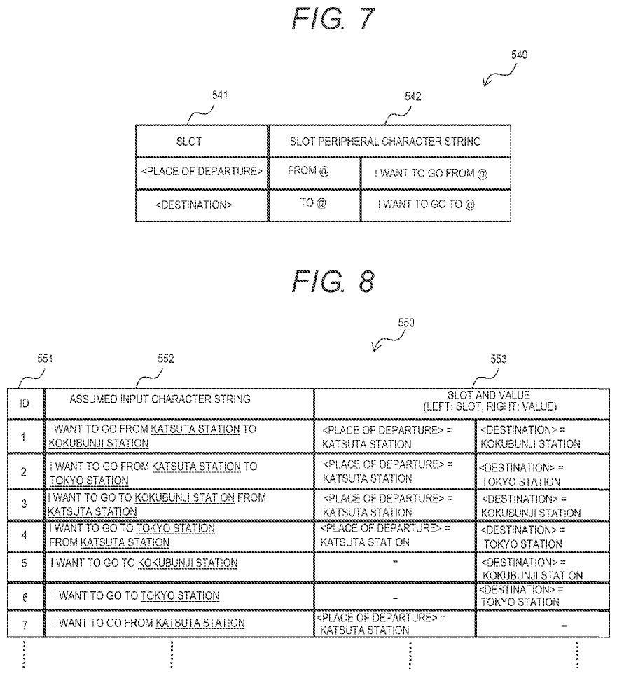

FIG. 7 is a configuration diagram showing a configuration of a peripheral character string list. In FIG. 7, the peripheral character string list 540 includes a slot 541 and a slot peripheral character string 542. The slot 541 is information for specifying the slot peripheral character string 542. For example, information of “<place of departure>” is registered in the slot 541. The slot peripheral character string 542 is information that is assumed in advance as a candidate of the peripheral character string disposed adjacent to the slot 541. For example, information of “from @” and “I want to go from @” is recorded in the slot peripheral character string 542 as a peripheral character string disposed adjacent to “<place of departure>”.

FIG. 8 is a configuration diagram showing a configuration of learning data. In FIG. 8, the learning data 550 includes an ID 551, an assumed input character string 552, a slot and value 553. The ID 551 is an identifier for uniquely identifying the learning data. The assumed input character string 552 is information defined as an input character string assumed in advance. Information related to the assumed input character strings defined in advance is registered in the assumed input character string 552, corresponding to each ID 551. For example, “1” of the ID 551 is registered with information of “I want to go from. Katsuta Station to Kokubunji Station”. The slot and value 553 is information for managing the slot and the value in the assumed input character string registered in the assumed input character string 552. For example, information of “<place of departure>=Katsuta Station” and “<destination>=Kokubunji Station” is registered in the slot and value 553, corresponding to “1” of the ID 551. Here, “<place of departure>” and “<destination>” are slots, and “Katsuta Station” and “Kokubunji Station” are values.

(Process Flow of Speech Dialogue System 2000)

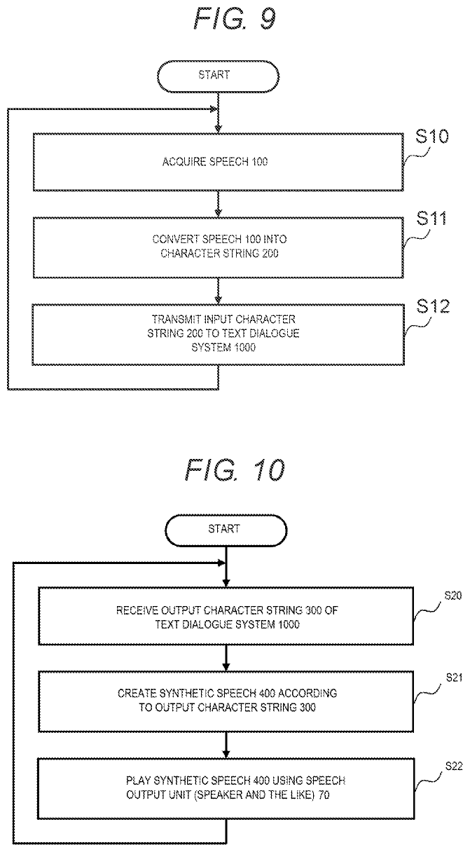

Next, the process flow of the speech dialogue system 2000 according to the first embodiment of the invention will be described. FIG. 9 shows a flow of speech recognition processing in the speech dialogue system 2000. As shown in FIG. 9, the speech input unit 10 including a microphone acquires the speech (input speech) 100 of a dialogue partner of the speech dialogue system 2000 (S10). The speech recognition unit 20 removes a sound (referred to as noise) other than the speech of the dialogue partner from the speech 100 acquired by the speech input unit 10, and converts text information included in the speech 100 into information of the input character string 200 (S11). Next, the speech recognition unit 20 transmits the information of the input character string 200 to the text dialogue system 1000 (S12), and the process proceeds to step S10. Thereafter, the processes of steps S10 to S12 are repeated.

Next, FIG. 10 shows a speech synthesis process flow in the speech dialogue system 2000. As shown in FIG. 10, the speech synthesis unit 60 receives information of the output character string 300 of the text dialogue system 1000 (S20). Next, the speech synthesis unit 60 creates the synthetic speech 400 from the output character string 300 (S21). Next, the speech synthesis unit 60 plays the synthetic speech (output speech) 400 using the speech output unit 70 including a speaker (S22), and the process proceeds to step S20. Thereafter, the processes of steps S20 to S22 are repeated.

As described above, by a series of process flow, the speech 100 of the dialogue partner input to the speech input unit 10 can be converted into the information of the input character string 200, and the information of the converted input character string 200 can be transmitted to the text dialogue system 1000. The information of the output character string 300 output from the text dialogue system 1000 can be converted into the synthetic speech 400, and the converted synthetic speech 400 can be played from the speech output unit 70 to the dialogue partner.

(Process Flow of Text Dialogue System 1000)

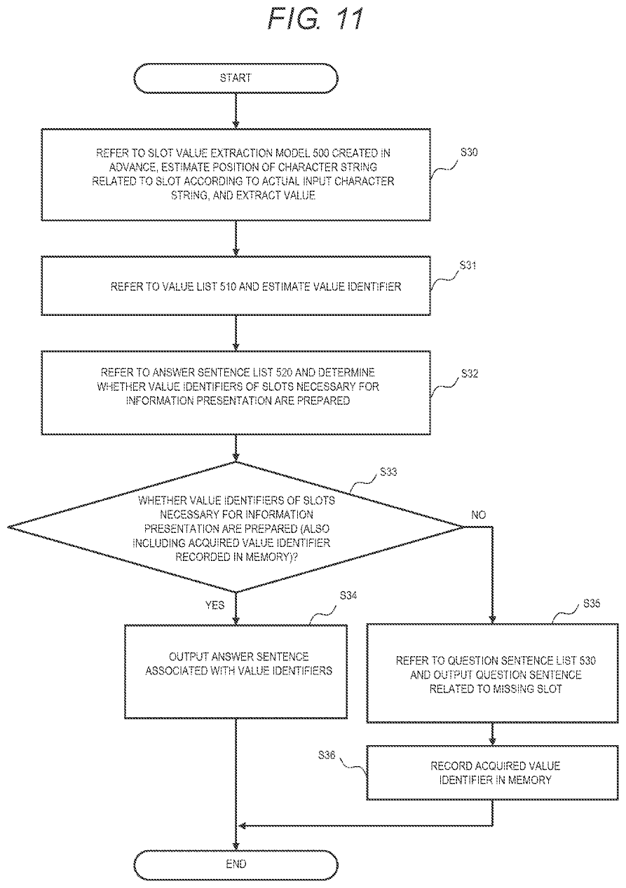

Next, the process flow of the text dialogue system 1000 will be described. FIG. 11 shows a basic process flow of the text dialogue system 1000. As shown in FIG. 11, with reference to the slot value extraction model 500 created in advance, the slot value extraction unit 30 estimates the position of a character string (value) related to a slot according to the actual input character string 200, extracts the value of the estimated position, and transfers information of the value and the slot to the value identifier estimation unit 40 (S30).

For example, when information of “I would like to go to Tokyo Station” is input as the input character string 200, the slot value extraction unit 30 compares the degree of similarity between the input character string 200 and the assumed input character string 502 of the slot value extraction model 500 of FIG. 3, selects “I want to go to Tokyo Station” from the assumed input character string 502 as an assumed input character string having a high degree of similarity, and estimates the position of the slot in the input character string 200 according to the slot (for example, <destination>) associated with the selected assumed input character string “I want to go to Tokyo Station”. For example, since the slot in the assumed input character string 502 is disposed adjacent to front (or back) of the character “I want to go to” (hereinafter referred to as slot peripheral character string), the position of the input character string 200 adjacent to front (or back) of the slot peripheral character string is estimated as the position of the slot. Finally, the slot value extraction unit 30 extracts a word at the position of the slot, for example, “Tokyo Station”, as a value. When a slot value extraction model created by machine learning is used, the slot value extraction unit 30 transfers the estimation result of the slot and value in the input character string 200 to the value identifier estimation unit 40 without using the slot and value extraction method described above.

Next, when the information of slot and value is received from the slot value extraction unit 30, the value identifier estimation unit 40 refers to the value list 510, and compares the degree of the similarity between the received value and the assumed value 512. When the degree of similarity is high, the value identifier 511 corresponding to the assumed value 512 is estimated, and information of the estimation result (value identifier) and information of the value are transferred to the answer narrow-down unit 50 (S31). For example, the value identifier estimation unit 40 estimates “<Tokyo station>” as the value identifier 511 when the received value is “Tokyo Station”.

Next, when the information (“<Tokyo station>”) of the estimation result (value identifier) and the information (“Tokyo Station”) of the value are received from the value identifier estimation unit 40, the answer narrow-down unit 50 refers to the answer sentence list 520, and determines whether the value identifiers of the slots necessary for information display have been prepared (S32, S33). For example, when the value identifiers of the slots necessary for displaying the riding time (for example: the value identifier of the slot <destination> is <Tokyo Station>, the value identifier of the slot <place of departure> is <Katsuta Station>) have been prepared, the answer narrow-down unit 50 outputs, for example, the information of “The riding time is approximately 2 hours.” as the answer sentence 523 associated with the value identifiers (“<Tokyo Station>”, “<Katsuta Station>”) (S34), and the processing in this routine ends.

On the other hand, when there is only a value identifier “<Tokyo Station>” indicating <destination> and the value identifiers of the slots necessary for display of riding time have not been prepared, the answer narrow-down unit 50 refers to the question sentence list 530 and outputs, for example, the information of “where is the place of departure” as the question sentence 532 prompting the user to input information related to the missing slot (for example, <place of departure>) (S35). Next, the answer narrow-down unit 50 records the information of the acquired value identifier in a memory (storage unit) (S36), and the processing in this routine ends.

As described above, by a series of process flow of the text dialogue system 1000, a plurality of question sentences are output to the user, appropriate information display are possible based on a plurality of answer sentences input by the user.

(Process Flow of Model Creating Device 1100)

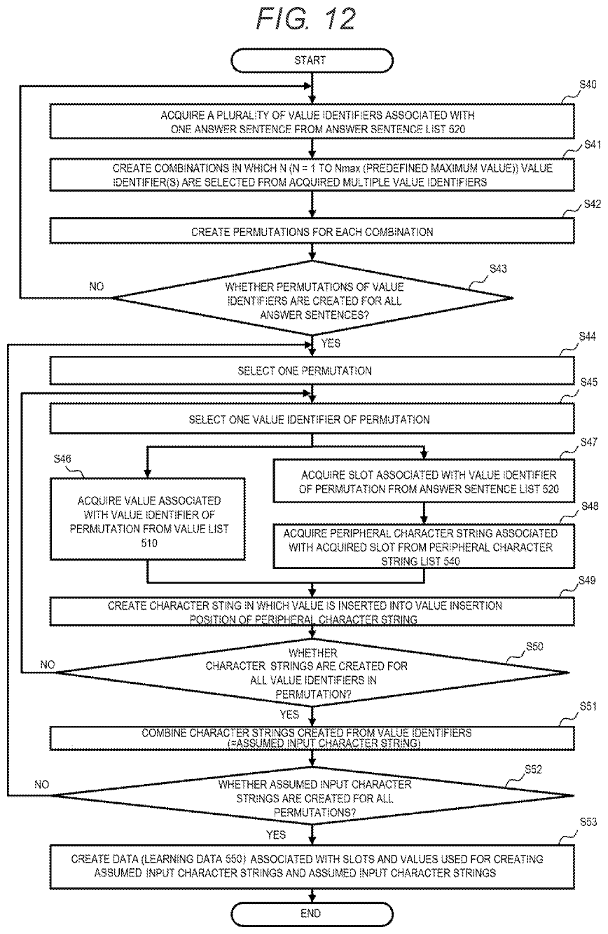

Next, the process flow of the model creating device 1100 according to the first embodiment of the invention will be described. FIG. 12 shows a process flow of the model creating device 1100. As shown in FIG. 12, the learning data creating unit 80 refers to the value list 510, the answer sentence list 520, and the peripheral character string list 540, and creates the learning data 550 based on the reference result. The learning data 550 includes an assumed input character string and a slot and value. A specific method of creating the learning data 550 will be described below.

(Method for Creating Learning Data 550)

In order to create an assumed input character string, the learning data creating unit 80 acquires a plurality of value identifiers associated with one answer sentence in the answer sentence 523 from the answer sentence list 520 (S40). Next, the learning data creation unit 80 selects N (N=1 to Nmax (predefined maximum value)) value identifier(s) from the acquired multiple value identifiers to create combinations (S41), and creates permutations for each created combination (S42). For example, when there are two value identifiers associated with the answer sentence 523, for example, M21=[<Katsuta Station>, <Tokyo Station>], M22=[<Tokyo Station>, <Katsuta Station>]) are created as permutations using two value identifiers such as “<Katsuta Station>” and “<Tokyo Station>”; and for example, M11=[<Katsuta Station>], M12=[<Tokyo Station>] are created as permutations using one value identifier.

Next, the learning data creation unit 80 determines whether permutations of the value identifiers have been created for all answer sentences (S43). In step S43, when a negative determination result is obtained, the process flow of the learning data creating unit 80 proceeds to step S40, and the processes of steps S40 to S43 are repeated. On the other hand, when a positive determination result is obtained in step S43, the learning data creating unit 80 selects one permutation from the permutations created in step S42 (S44), and selects one value identifier of the selected permutation (S45).

Next, the learning data creating unit 80 refers to the value list 510 based on the value identifier selected from the permutation, and acquires, from the assumed value 512 in the value list 510, a value such as “Katsuta Station” as the value associated with the value identifier (for example, <Katsuta Station>) of the permutation such as M21=[<Katsuta Station>, <Tokyo Station>] (S46).

At this time, the learning data creating unit 80 refers to the answer sentence list 520 based on the value identifier selected from the permutation, and acquires, from the slot and value identifier 522 in the answer sentence list 520, a slot such as “<place of departure>” as the slot associated with a value identifier (for example, <Katsuta Station>) of the permutation such as M21=[<Katsuta Station>, <Tokyo Station>]) (S47). Further, the learning data creating unit 80 refers to the peripheral character string list 540 based on the obtained slot “<place of departure>”, and acquires, from the slot peripheral character string 542 in the peripheral character string list 540, a peripheral character string such as “from @” as the peripheral character string associated with the acquired slot “place of departure” (S48).

Next, based on the value (“Katsuta Station”) acquired in step S46, the slot (<place of departure>) acquired in step S47, and the peripheral character string (“from @”) acquired in step S48, the learning data creating unit 80 creates a character string such as C1=“from Katsuta Station” in which the value such as “Katsuta Station” is inserted into a value insertion position of the peripheral character string such as “@” (S49).

Next, the learning data creating unit 80 determines whether character strings have been created for all the value identifiers in the permutation (S50). When a negative determination result is obtained in step S50, the process flow of the learning data creating unit 80 proceeds to step S45, and the processes of steps S45 to S50 are repeated.

At this time, the learning data creating unit 80 acquires, from the assumed value 512 in the value list 510, a value such as “Tokyo station” as the value associated with another value identifier of the permutation M21 such as <Tokyo Station>. Further, the learning data creating unit 80 acquires, from the slot and value identifier 522 in the answer sentence list 520, a slot such as “<destination>” as the slot associated with the other value identifier such as <Tokyo Station>. Still further, the learning data creating unit 80 refers to the peripheral character string list 540 based on the acquired slot “<destination>”, and acquires, from the slot peripheral character string 542 in the peripheral character string list 540, a peripheral character string such as “I want to go to @” as the peripheral character string associated with the acquired slot “<destination>”. At this time, the learning data creating unit 80 creates a character string such as C2=“I want to go to Tokyo Station” in which the value (for example, “Tokyo Station”) is inserted into the value insertion position of the peripheral character string.

On the other hand, when a positive determination result is obtained in step S50, the learning data creating unit 80 combines the character strings created from the value identifiers to create information of the assumed input character string (S51). For example, the learning data creating unit 80 combines the character strings created from the value identifiers included in the permutation to create an assumed input character string, for example, C1+C2=“I want to go from Katsuta Station to Tokyo station”.

Next, the learning data creating unit 80 determines whether the assumed input character strings have been created for all the permutations (S52). When a negative determination result is obtained in step S52, the process flow of the learning data creating unit 80 proceeds to step S45, and the processes of steps S44 to S52 are repeated. On the other hand, when a positive determination result is obtained in step S52, the learning data creating unit 80 creates, as learning data (first learning data) 550, data associated with the slots and values used for creating a plurality of assumed input character strings and associated with the assumed input character strings (S53), and the processing in this routine ends.

At this time, for each combination of the permutations of the value identifiers, the learning data creating unit 80 respectively acquires the values associated with the value identifiers of elements belonging to the permutations of the value identifier from the value list 510 as the values of elements, acquires the slots associated with the value identifiers of elements from the answer sentence list 520 as the slots of elements, and acquires the peripheral character strings associated with the slots of elements from the peripheral character string list 540 as the peripheral character strings of elements. Then, the learning data creating unit 80 creates the character strings of elements by combining the acquired values of elements and the acquired peripheral character strings of elements, creates a plurality of assumed input character strings by combining the character strings of elements, and creates the first learning data 550 associated with the assumed input character strings and the slots and values of elements based on the plurality of created assumed input character strings and the slots and values of elements used for creating the plurality of assumed input character strings.

(Model Creating Method)

The model creating unit 90 creates a slot value extraction model (first slot value extraction model) 500 according to the learning data (first learning data) 550. In the slot value extraction model 500, the assumed input character string and the slot and value defined in advance are registered. For example, the learning data 550 and the slot value extraction model 500 may be the same. Further, the slot value extraction model 500 may be created by machine learning (for example, the method of conditional random fields) using the assumed input character string of the learning data 550 and the slot and value as inputs.

According to the present embodiment, a plurality of slot value extraction models can be automatically created. As a result, the work cost required for creating the slot value extraction models can be reduced.

### Second Embodiment

According to the second embodiment, highly accurate slot value extraction can be achieved by switching between a plurality of slot value extraction models (first and second slot value extraction models) in the speech dialogue system 2000 described in the first embodiment. Further, the work cost required for creating the plurality of slot value extraction models is reduced.

In the first embodiment, when the value identifiers of the slots necessary for information display have not been prepared, the answer narrow-down unit 50 refers to the question sentence list 530 and outputs a question sentence (for example, where is the place of departure?) that prompts the user to input information related to the missing slot (for example, <place of departure>). In contrast, in order to extract a slot value with high accuracy from an input character string of a dialogue partner, the slot value extraction unit 30 according to the second embodiment uses a slot value extraction model (second slot value extraction model) in which only an assumed input character string related to an acquired slot is not included. Since only the assumed input character string related to the acquired slot is not included in the slot value extraction model, there is no possibility that the slot value extraction unit erroneously extracts the acquired slot. Therefore, accuracy of slot value extraction according to the second embodiment is higher than that in the first embodiment.

Further, in order to reduce work cost necessary for creating a plurality of slot value extraction models, the learning data creating unit 80 according to the second embodiment creates the second learning data by only removing the assumed input character string related to the specific slot from the learning data (first learning data) 550 created in the first embodiment. Then, the model creating unit 90 creates the second slot value extraction model from the second learning data.

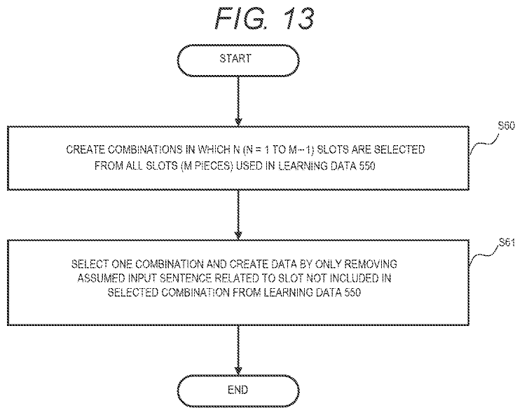

FIG. 13 shows a process flow of creating the learning data. As shown in FIG. 13, the learning data creating unit 80 creates combinations in which N (N=1 to M−1) slots are selected from all slots (M pieces) used in the learning data 550 created in the first embodiment. Then, for each combination, data (second learning data) is created by only removing the assumed input character string related to the slot not included in the combination from the learning data 550.

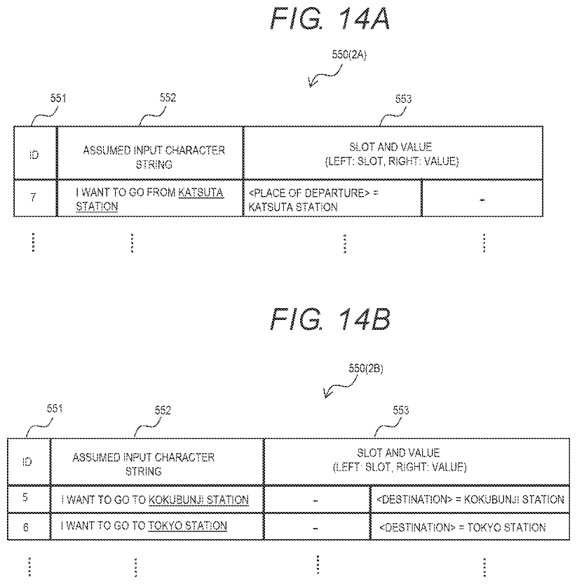

Specifically, in the case of the learning data 550 created in the first embodiment, the learning data creating unit 80 creates combinations, for example, two types, in which N (N=1 to M−1) slots are selected from all the slots (M=2) (S60). Next, the learning data creating unit 80 selects one combination from the combinations (two types) created in step S60, and for the selected combination, the learning data (the second learning data) 550(2A, 2B) is created, in which only the assumed input sentence (assumed input character string) related to the slot not included in the combination is removed from the learning data 550 (S61), as is shown in FIG. 14.

FIG. 14A shows an example of the learning data 550(2A) in which only the assumed input character strings related to the specific slots “<destination>” is removed from the learning data 550 in FIG. 8. That is, the learning data 550 (2A) in FIG. 14A is the learning data in which information whose ID 551 is “1” to “6”, that is, information having “<destination>” in the slot and value 553 of the learning data 550 in FIG. 8 is removed. Further, FIG. 14B shows an example of the learning data 550 (2B) obtained by only removing the assumed input character strings related to the specific slots “<place of departure>” from the learning data 550 in FIG. 8. That is, the learning data 550 (2B) in FIG. 14B is learning data in which the information whose ID 551 is “1” to “4” and “7”, that is, the information having “<place of departure>” in the slot and value 553 of the learning data 550 in FIG. 8 is removed.

According to the present embodiment, highly accurate slot value extraction can be achieved by switching the plurality of slot value extraction models from the first slot value extraction model to the second slot value extraction model in the speech dialogue system 2000 described in the first embodiment. In addition, the work cost required for creating the plurality of slot value extraction models can be reduced.

### Third Embodiment

In order to extract a slot value with high accuracy from an input character string of a dialogue partner, the slot value extraction unit 30 according to the third embodiment switches a slot value extraction model to be used from a first slot value extraction model to a third slot value extraction model based on a dialogue log. An example of the dialogue log is shown in FIG. 15.

FIG. 15 is a configuration diagram showing a configuration of the dialogue log. A dialogue log 560 includes an ID 561, a question sentence 562, and a slot 563. The slot 563 includes <place of departure> 564, <destination> 565, <departure time> 566, <place of departure> <destination> 567, <destination> <departure time> 568, <departure time> <place of departure> 569, and <place of departure> <destination> <departure time> 570.

The ID 561 is an identifier for uniquely identifying the dialogue log. The question sentence 562 is information for managing a question sentence for a user. In the question sentence 562, for example, information of “Where is the destination?” is registered. The slot 563 is information for managing the probability (ratio) of the slot included in the question sentence 562. For example, as indicated by “1” in the ID 561, “-” (no question output) is shown as the question sentence 562, and when the probability of including the information of “<place of departure>” is “20%”, the information of “20%” is registered in <place of departure> 564. As indicated by “2” in the ID 561, “Where is the destination?” is shown as the question sentence 562, and when the probability of including the information of “<place of departure>” is “0%”, the information of “0%” is registered in <place of departure> 564. As indicated by “3” in the ID 561, “Where is the place of departure?” is shown as the question sentence 562, and when the probability of including the information of “<place of departure>” is “80%”, the information of “80%” is registered in <place of departure> 564. As indicated by “4” in the ID 561, “When is the departure time?” is shown as the question sentence 562, and when the probability of including the information of “<place of departure>” is “0%”, the information of “0%” is registered in <place of departure> 564.

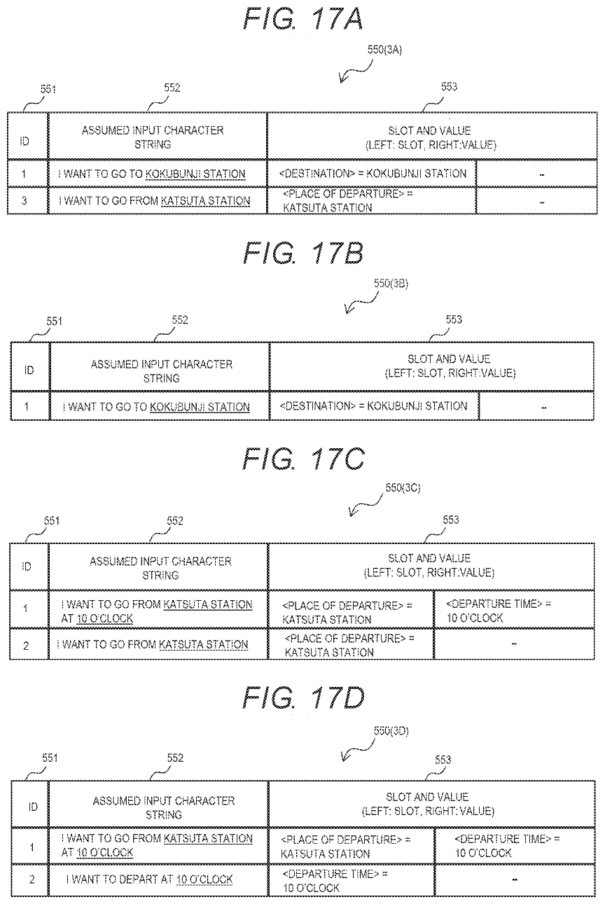

The dialogue log shows probabilities of respective slots of being included in the input character string of the dialogue partner. For example, when there is no question sentence output of the text dialogue system 1000 (“1” in the ID 561), the probability that only the character string related to <place of departure> 564 in the slot 563 is included in the input character string 200 of the dialogue partner is “20%” which is equal to or higher than a threshold (for example, 10%), and the probability that only the character string related to <destination> 565 in the slot 563 is included in the input character string 200 is “80%” which is equal to or higher than the threshold. Therefore, in order to improve accuracy of slot value extraction, in the slot value extraction of the input character string 200 when there is no output of the question sentence, the slot value extraction unit 30 uses the slot value extraction model 550 (see FIG. 17A) in which both the assumed input character string only related to <place of departure> 564 in the slot 563 and the assumed input character string only related to <destination> 565 in the slot 563 are registered.

Similarly, in the slot value extraction of the input character string 200 for the question sentence “Where is the destination?”, the slot value extraction unit 30 uses the slot value extraction model 550 (see FIG. 17B) in which the assumed input character string only related to <destination> 565 in the slot 563 is registered.

In addition, in the slot value extraction of the input character string 200 for the question sentence “Where is the place of departure?”, the slot value extraction unit 30 uses the slot value extraction model 550 (see FIG. 17C) in which the assumed input character string only related to <place of departure> 564 in the slot 563 and the assumed input character string which includes both <departure time> 566 and <place of departure> 564 in the slot 563 are registered.

In addition, in the slot value extraction of the input character string 200 for the question sentence “When is the departure time?”, the slot value extraction unit 30 uses the slot value extraction model 550 (see FIG. 17D) in which the assumed input character string only related to <departure time> 566 in the slot 563 and the assumed input character string which includes both <departure time> 566 and <place of departure> 564 in the slot 563 are registered.

Therefore, based on the dialogue log 560, it is necessary to manage the slot value extraction model 550 in which the assumed input character string related to the specific slot is registered with a management table.

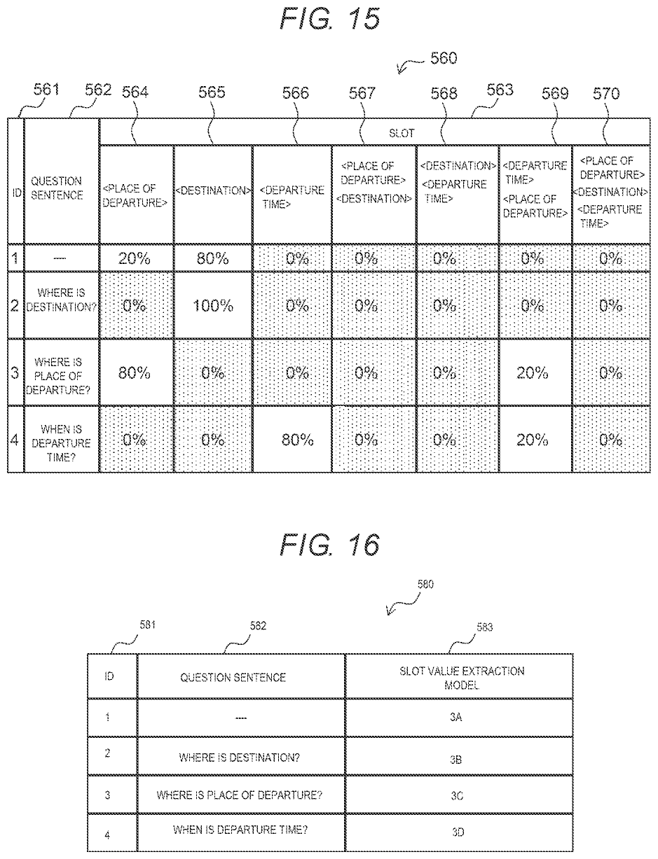

FIG. 16 is a configuration diagram showing a configuration of the management table. In FIG. 16, a management table 580 is a table for managing the relationship between the question sentence and the slot value extraction model and includes an ID 581, a question sentence 582, and a slot value extraction model 583. The ID 581 is an identifier for uniquely identifying the question sentence 582. The question sentence 582 is information for managing the question sentence for the user. In the question sentence 582, for example, information of “Where is the destination?” is registered. The slot value extraction model 583 is information that specifies the learning data (third learning data) 550 (3A to 3D) for creating the slot value extraction model (third slot value extraction model) 500 (3A to 3D). For example, “3A” is registered in the slot value extraction model 583 as information for specifying the learning data 550 (3A).

At this time, the learning data creating unit 80 creates the learning data related to the specific slot based on the dialogue log 560 in order to reduce the work cost necessary for creating the plurality of slot value extraction models 500 (see FIG. 17). On the other hand, the model creating unit 90 creates the slot value extraction models 500 (3A to 3D) from the various learning data 550 (3A to 3D) created by the learning data creating unit 80.

FIG. 17 is a configuration diagram showing a configuration of learning data related to the specific slots based on the dialogue log. FIG. 17A shows the learning data 550 (3A) specified by “3A” in the slot value extraction model 583 of the management table 580. The learning data 550 (3A) includes the ID 551, the assumed input character string 552, and the slot and value 553. As indicated by “1” in the ID 551, for example, “I want to go to Kokubunji Station” is registered in the assumed input 552 as information only related to the destination, “<destination>” is registered in the slot and value 553 as the slot, and “Kokubunji Station” is registered in the slot and value 553 as the value. In addition, as indicated by “3” in the ID 551, for example, “I want to go from Katsuta Station” is registered in the assumed input 552 as the information only related to the place of departure, “<place of departure>” is registered in the slot and value 553 as the slot, and “Katsuta Station” is registered in the slot and value 553 as the value.

FIG. 17B shows the learning data 550 (3B) identified by “3B” in the slot value extraction model 583 of the management table 580. The learning data 550 (3B) includes the ID 551, the assumed input character string 552, and the slot and value 553. As indicated by “1” in the ID 551, for example, “I want to go to Kokubunji Station” is registered in the assumed input 552 of the learning data 550 (3B) as the information only related to the destination, “<destination>” is registered in the slot and value 553 as the slot, and “Kokubunji Station” is registered in the slot and value 553 as the value.

FIG. 17C shows the learning data 550 (3C) identified by “3C” in the slot value extraction model 583 of the management table 580. The learning data 550 (3C) includes the ID 551, the assumed input character string 552, and the slot and value 553. As indicated by “1” in the ID 551, for example, “I want to go from Katsuta Station at 10 o'clock” is registered in the assumed input 552 of the learning data 550 (3C) as the information related to the departure time and the place of departure, “<place of departure>” and “<departure time>” are registered in the slot and value 553 as the slots, and “Katsuta Station” and “<10 o'clock>” are registered in the slot and value 553 as the values. In addition, as indicated by “2” in the ID 551, for example, “I want to go from Katsuta Station” is registered in the assumed input 552 of the learning data 550 (3C) as the information only related to the place of departure, “<place of departure>” is registered in the slot and value 553 as the slot, and “Katsuta Station” is registered in the slot and value 553 as the value.

FIG. 17D shows the learning data 550 (3D) identified by “3D” in the slot value extraction model 583 of the management table 580. The learning data 550 (3D) includes the ID 551, the assumed input character string 552, and the slot and value 553. As indicated by “1” in the ID 551, for example, “I want to go from Katsuta Station at 10 o'clock” is registered in the assumed input 552 of the learning data 550 (3D) as the information related to the departure time and the place of departure, “<place of departure>” and “<departure time>” are registered in the slot and value 553 as the slots, and “Katsuta Station” and “<10 o'clock>” are registered in the slot and value 553 as the values. In addition, as indicated by “2” in the ID 551, for example, “I want to depart at 10 o'clock” is registered in the assumed input 552 of the learning data 550 (3D) as the information only related to the departure time, “<departure time>” is registered in the slot and value 553 as the slot, and “10 o'clock” is registered in the slot and value 553 as the value.

According to the present embodiment, highly accurate slot value extraction can be achieved by switching the plurality of slot value extraction models from the first slot value extraction model to the third slot value extraction model in the speech dialogue system 2000 described in the first embodiment. In addition, the work cost required for creating the plurality of slot value extraction models can be reduced.

While the invention made by the inventor has been described in detail based on the embodiments, the invention is not limited thereto, and various modifications can be made without departing from the scope of the invention. For example, the value list 510 and the answer sentence list 520 may be arranged in the model creating device 1100.

The invention can be widely applied to a dialogue system in which voice and text are input such as a dialogue robot equipped with a speech dialogue system and a chat bot equipped with a text dialogue system.

The configurations, functions, and the like may be achieved entirely or partially by hardware, for example, by designing them in an integrated circuit. In addition, the configurations, functions, and the like may be achieved by software by interpreting and executing a program for achieving each function by a processor. Information such as programs, tables and files for realizing the functions may be recorded and stored in a storage device such as a memory, a hard disk, or a solid state drive (SSD), or in a recording medium such as an integrated circuit (IC) card, a secure digital (SD) memory card, or a digital versatile disc (DVD).

1. A speech dialogue system that converts an input speech into information of an input character string, creates an output character string containing information of an answer sentence or a question sentence based on the converted information of the input character string, converts information of the created output character string into a synthetic speech, and outputs the converted synthetic speech as an output speech, the speech dialogue system comprising:
a value list in which a plurality of values indicating candidates of a character string assumed in advance, which are information constituting a character string, and a plurality of value identifiers that identify each of the plurality of values are stored in association;
an answer sentence list in which each of a plurality of slots indicating an identifier that identifies the information constituting the character string and each of the plurality of value identifiers are stored in association, and each of the plurality of slots and each of the plurality of value identifiers are stored in association with one or more answer sentences;
a peripheral character string list in which each of the plurality of slots and each of a plurality of peripheral character strings arranged adjacent to each of the plurality of slots are stored in association;
a storage unit that stores a plurality of assumed input character strings assumed in advance and a plurality of slot value extraction models including one or more of the slots and the values associated with each of the plurality of assumed input character strings;
a slot value extraction unit that compares a similarity between the input character string and each of the assumed input character strings in the plurality of slot value extraction models, estimates a position of the slot in the input character string based on the slot associated with an assumed input character string having a high degree of similarity, and extracts the value corresponding to the estimated position of the slot from the input character string;
a learning data creating unit that creates first learning data based on the value list, the answer sentence list, and the peripheral character string list; and
a model creating unit that creates a first slot value extraction model based on the first learning data and stores the created first slot value extraction model in the storage unit as a model belonging to the plurality of slot value extraction models.

2. The speech dialogue system according to claim 1, wherein
the learning data creating unit is configured to:
based on the answer sentence list, create one or more combinations of the value identifiers associated with the answer sentence in the answer sentence list, and create a permutation of the value identifiers for each of the one or more combinations;
for each combination of the permutation of the value identifiers, respectively acquire the values associated with the value identifiers of elements belonging to the permutation of the value identifiers from the value list as values of the elements, respectively acquire the slots associated with the value identifiers of the elements from the answer sentence list as slots of the elements, and further respectively acquire the peripheral character strings associated with the slots of the elements from the peripheral character string list as peripheral character strings of the elements;
for each combination of the permutation of the value identifiers, create a character string of the elements by combining the acquired values of the elements and the acquired peripheral character strings of the elements, and create a plurality of assumed input character strings by combining the character string of the elements; and
create the first learning data associated with the assumed input character strings and the slots and values of the elements, based on the plurality of created assumed input character strings and the slots and values of the elements used for creating each of the plurality of assumed input character strings.

3. The speech dialogue system according to claim 2, wherein
the learning data creating unit is configured to:
create a combination of one or more specific slots of the slots of the elements associated with the first learning data, and create second learning data by excluding, from the first learning data, learning data associated with a slot excluded from the created combination of the specific slots; and
the model creating unit is configured to:
create a second slot value extraction model based on the second learning data, and store the created second slot value extraction model in the storage unit as a model belonging to the plurality of slot value extraction models.

4. The speech dialogue system according to claim 2, further comprising:
a dialogue log associated with a probability that at least the slots of the elements are included in one or more voice output text strings set in advance, wherein
the learning data creating unit is configured to:
create third learning data by extracting, from the first learning data, data including the assumed input character string related to a slot that, among the slots of the elements associated with the first learning data, has a probability defined by the dialogue log which is greater than or equal to a threshold; and
the model creating unit is configured to:
create a third slot value extraction model based on the third learning data and store the created third slot value extraction model in the storage unit as a model belonging to the plurality of slot value extraction models.

5. The speech dialogue system according to claim 1, further comprising:
a question sentence list in which each of the plurality of slots and each of a plurality of question sentences are stored in association;
a value identifier estimation unit that compares a similarity between the value extracted by the slot value extraction unit and the values in the value list, and estimates a value identifier associated with the value with a high similarity as a value identifier of the value extracted by the slot value extraction unit; and
an answer narrow-down unit that refers to the answer sentence list based on the value identifier estimated by the value identifier estimation unit, and outputs an answer sentence associated with a value identifier of a slot used for information display as the output character string when the value identifier of the slot used for information display exists in the answer sentences, and refers to the question sentence list and outputs a question sentence associated with a missing slot used for information display as the output character string when the value identifier of the slot used for information display does not exist in the answer sentences.

6. A model creating device, comprising:
a value list in which a plurality of values indicating candidates of a character string assumed in advance, which are information constituting a character string, and a plurality of value identifiers that identify each of the plurality of values are stored in association;
an answer sentence list in which each of a plurality of slots indicating an identifier that identifies the information constituting the character string and each of the plurality of value identifiers are stored in association, and each of the plurality of slots and each of the plurality of value identifiers are stored in association with one or more answer sentences;
a peripheral character string list in which each of the plurality of slots and each of a plurality of peripheral character strings arranged adjacent to each of the plurality of slots are stored in association;
a learning data creating unit that creates first learning data based on the value list, the answer sentence list, and the peripheral character string list; and
a model creating unit that creates a first slot value extraction model based on the first learning data, wherein
the learning data creating unit is configured to:
based on the answer sentence list, create one or more combinations of the value identifiers associated with the answer sentence in the answer sentence list, and create a permutation of the value identifiers for each of the one or more combinations;
for each combination of the permutation of the value identifiers, respectively acquire values associated with value identifiers of elements belonging to the permutation of the value identifiers from the value list as values of the elements, respectively acquire slots associated with the value identifiers of the elements from the answer sentence list as slots of the elements, and further respectively acquire the peripheral character strings associated with the slots of the elements from the peripheral character string list as peripheral character strings of the elements;
for each combination of the permutations of the value identifiers, create a character string of the elements by combining the acquired values of the elements and the acquired peripheral character strings of the elements, and create a plurality of assumed input character strings by combining the character string of the elements; and
create the first learning data associated with the assumed input character strings and the slots and values of the elements, based on the plurality of created assumed input character strings and the slots and values of the elements used for creating each of the plurality of assumed input character strings.

7. The model creating device according to claim 6, wherein
the learning data creating unit is configured to:
create a combination of one or more specific slots of the slots of the elements associated with the first learning data, and create second learning data by excluding, from the first learning data, learning data associated with a slot excluded from the created combination of the specific slots; and
the model creating unit is configured to:
create a second slot value extraction model based on the second learning data.

8. The model creating device according to claim 6, further comprising:
a dialogue log associated with a probability that at least the slots of the elements are included in one or more voice output text strings set in advance, wherein
the learning data creating unit is configured to:
create third learning data by extracting, from the first learning data, data including an assumed input character string related to a slot that, among the slots of the elements associated with the first learning data, has a probability defined by the dialogue log which is greater than or equal to a threshold; and
the model creating unit is configured to:
create a third slot value extraction model based on the third learning data.

9. A model creating method used in a model creating device that includes: a value list in which a plurality of values indicating candidates of a character string assumed in advance, which are information constituting a character string, and a plurality of value identifiers that identify each of the plurality of values are stored in association; an answer sentence list in which each of a plurality of slots indicating an identifier that identifies the information constituting the character string and each of the plurality of value identifiers are stored in association, and each of the plurality of slots and each of the plurality of value identifiers are stored in association with one or more answer sentences; a peripheral character string list in which each of the plurality of slots and each of a plurality of peripheral character strings arranged adjacent to each of the plurality of slots are stored in association; a learning data creating unit that creates first learning data based on the value list, the answer sentence list, and the peripheral character string list; and a model creating unit that creates a first slot value extraction model based on the first learning data, the method comprising flowing steps by the learning data creating unit:
based on the answer sentence list, creating one or more combinations of the value identifiers associated with the answer sentence in the answer sentence list, and creating a permutation of the value identifiers for each of the one or more combinations;
for each combination of the permutation of the value identifiers, respectively acquiring values associated with value identifiers of elements belonging to the permutations of the value identifiers from the value list as values of the elements, respectively acquiring slots associated with the value identifiers of the elements from the answer sentence list as slots of the elements, and further respectively acquiring the peripheral character strings associated with the slots of the elements from the peripheral character string list as peripheral character strings of the elements;
for each combination of the permutation of the value identifiers, creating a character string of the elements by combining the acquired values of the elements and the acquired peripheral character strings of the elements, and creating a plurality of assumed input character strings by combining the character string of the elements; and
creating the first learning data associated with the assumed input character strings and the slots and values of the elements, based on the plurality of the created assumed input character strings and the slots and values of the elements used for creating each of the plurality of assumed input character strings.

10. The model creating method according to claim 9, comprising following steps by the learning data creating unit:
creating, by the learning data creating unit, a combination of one or more specific slots of the slots of the elements associated with the first learning data, and creating second learning data by excluding, from the first learning data, learning data associated with a slot excluded from the created combination of the specific slots; and
creating, by the model creating unit, a second slot value extraction model based on the created second learning data.

11. The model creating method according to claim 9, wherein
the model creating device further includes a dialogue log associated with a probability that at least the slots of the elements are included in one or more voice output text strings set in advance, and
the model creating method further includes following steps:
creating, by the learning data creating unit, third learning data by extracting, from the first learning data, data including an assumed input character string related to a slot that, among the slots of the elements associated with the first learning data, has a probability defined by the dialogue log which is greater than or equal to a threshold; and
creating, by the model creating unit, a third slot value extraction model based on the created third learning data.
